(19) United States
(12) Patent Application Publication
(10) Pub. No.: US 2008/0192312 A1
(43) Pub. Date: Aug. 14, 2008

(54) HOLOGRAPHIC INFORMATION DISPLAY

(75) Inventors: Ulrich HENDRICKS, Gaufelden (DE); Sven KRUGER, Berlin (DE); Peter BRANDT, Aschaffenburg (DE); Heiko CHARLE, Russelsheim (DE); Daniel SAHLBOM, Mellerud (SE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/027,052

(22) Filed: Feb. 6, 2008

(30) Foreign Application Priority Data
Feb. 9, 2007 (DE) 102007007162.2

(51) Int. Cl. G02B 27/01

(52) U.S. Cl. 359/13

(57) ABSTRACT

The invention relates to a holographic information display for a motor vehicle for projecting a virtual display element. A data processing device provides a hologram for the virtual display element to be projected. A control device in each case emits an individual control signal for a plurality of segments of the hologram. A plurality of optical phase delay cells which can be individually adjusted by the control device and are arranged on a face illuminated by the light beam, delay the fraction of the light beam incident thereon in each case in the phase in response to the respective individual control signal.

### CROSS-REFERENCE TO RELATED APPLICATION

This application claims priority to German Application No. DE 10 2007 007 162.2, filed Feb. 9, 2007, which is hereby incorporated in its entirety by reference.

### TECHNICAL FIELD

The present invention relates to a holographic information display (HID), which is used in or for a vehicle for projecting an image. In addition, the invention relates to a method for projecting the virtual display element using the holographic information display according to the invention.

By means of head-up information displays (HUDs), information which the driver of the motor vehicle possibly requires can be superimposed on the windscreen for the driver of a motor vehicle. The head-up information display contains a projector and a plurality of lenses and/or mirror elements, in particular diffractive optical systems as correction lenses to project a distortion-free image at a virtual distance onto the windscreen (see DE 103 44 688 A1 as an example). The optical structure required for this, including the correction elements, which have to be adapted to a variety of differently shaped windscreens, make it difficult to implement and set up an HUD in motor vehicles.

One object of the present invention consists in providing a projection system for information that can easily be implemented and set up in a motor vehicle and various types of motor vehicles.

### SUMMARY

Other objects, features, and characteristics of the present invention will become apparent from the subsequent detailed description and appended claims, taken in conjunction with the accompanying drawings and background.

In accordance with one exemplary embodiment, a holographic information display is provided for a motor vehicle for projecting an image with a data processing device for providing a hologram for the virtual display element to be projected; a control device, which in each case emits an individual control signal for a plurality of segments of the hologram; a light source for emitting a light beam; and a plurality of optical phase delay cells which can be individually adjusted by the control device and are arranged on a face illuminated by the light beam to delay the fraction of the light beam which is incident thereon in each case in the phase in response to the respective individual control signal.

In accordance with one exemplary embodiment, a method is provided according to the invention for projecting a display element using a holographic information display. The method includes, but is not limited to: providing a hologram for a two-dimensional or three-dimensional virtual display element by means of the data processing device; emitting individual control signals for a plurality of portions of the hologram by means of the control device; adjusting the respective phase delay of the plurality of phase delay devices in response to the respective individual control signal; and illuminating the plurality of phase delay devices by means of the light source, so the virtual display element is generated by the phase-delayed light beams of the light source.

An advantage of the holographic information display consists in that no correction optical systems are required to show the display elements in undistorted form. It is already sufficient as a measure for this to provide the associated hologram. The intensity of one or more colors is also shown with spatial resolution in an image.

Furthermore, in a hologram, the phase of a light wave field with one or more wavelengths is shown with spatial resolution in the surface of the hologram.

According to the Huyghens principle, complete knowledge about a light wave field in any plane of section through a three-dimensional space is already sufficient to completely reconstruct the light wave field in the three-dimensional space. Complete knowledge requires knowledge about the phase of the light wave field in the plane of section.

The plane of section is reproduced by the hologram. On illumination, a spherical wave with the starting phase predetermined by the hologram is emitted from each point of the hologram. The superposition of the individual wavelets produces the light wave field in the space, the so-called reconstructed hologram. The human eye does not perceive the phase. However, the superposition leads to clear interference patterns, the intensity distributions of which are perceivable. In a reproduction of a spatial intensity distribution, instead of the absolute phases in a hologram, a more simply implementable relative phase may be used.

The complete reconstruction of the light wave field cannot be distinguished from the light wave field to be reproduced. Thus, the same projection patterns on both eyes of an observer and the three-dimensional vision connected therewith are thus produced.

The display element may be a three-dimensional object or simply a two-dimensional image to be shown. The hologram to the display element, in other words the spatial resolution phase information, is provided. It can either be currently calculated or be present, stored as a pattern.

A simple calculation method for the hologram illustrating this is based in principle on the fact that an emanating spherical wave (Huygens wavelet) is assumed for each point of the display element. The starting phase of each spherical wave on the virtual display element is to be selected for light regions displaced through 90° with respect to dark regions. Then, at each point of the hologram, the phases of the individual spherical waves incident on the respective point of the hologram are added up. The added up phase is stored as the phase of the hologram at the respective point. All the distorting optical elements, for example lenses, curved reflective surfaces, are taken into account in the propagation of the spherical waves through the space. Double reflections on the front and rear of glass panes are nevertheless taken into account. If a hologram of this type is used to reconstruct the light wave field in the space, the light wave field from the hologram traverses the distorting optical elements, double reflections, etc. backwards and the virtual display element appears in the same manner as it was used to determine the hologram. In the knowledge of the space and the optical elements contained therein, a distortion-free representation of the virtual display element can be achieved solely by providing the suitable hologram for the virtual display element.

More efficient calculation methods for determining the hologram are based on a Fourier transformation of the space. The basic idea contained in this calculation method remains unchanged, however.

In a development, the projected virtual display element is directed by a deflection device into the range of vision of a driver of the motor vehicle. A corresponding deflection device may be the windscreen of the vehicle. Imaging errors of the optical deflection device may be taken into account in a corrective manner in the hologram. The driver can continue to look through the windscreen while driving and at the same time perceives the display elements superimposed for him virtually into the range of vision.

The physical realisation of the hologram takes place by means of the plurality of adjustable phase delay cells. The incident light, with spatial resolution, undergoes a defined relative phase delay.

The phase delay cells may be operated in transmission mode or in reflection mode. The phase delay cells may be arranged in lines and columns. The phase delay cells may be arranged in a flat surface or optionally also on a curved surface. The plane of section described above through the space does not imperatively have to be flat. In the individual configurations it may be expedient to arrange the phase delay cells on curved surfaces or on surfaces tilted with respect to one another.

Provided in the delay cells in one embodiment is a delay means, by means of which the phase of the incident light beam can be delayed between 0 and 180 degrees in at least two steps. In the simplest configuration, two phase delay cells may be adjusted in such a way that the light respectively emitted from them may be co-phasal or in phase opposition. The contrast and the image sharpness of the virtual display element shown correlates with the accuracy with which the relative phase differences of the phase delay cells can be adjusted. It may therefore be advantageous to provide a delay means which achieves an adjustment of the phase in fractions of 180 degrees.

In a further configuration, the phase of the incident light beam may be delayed continuously by a delay means. One configuration provides for the provision of delay means by way of liquid crystals and/or ferroelectric liquid crystals, which delay the phase of the incident light in response to an electrical field generated by the control signal. The delay means optionally contains polarisation filters to ensure a rigidly defined polarity of the light beams and to avoid polarisation rotations.

According to a development, the data processing device provides a computing device for determining the hologram for the virtual display element to be projected and/or a memory device for loading the hologram for the virtual display element to be projected. The data processing device may be integrated in the control device.

In one configuration, the light source is configured as a coherent light source for emitting a coherent light beam. The light source may be a laser light source. The coherence length should preferably be several metres. Apart from laser beam sources, inter alia spectral lamps may also be used, the emission bandwidth of which is adequately narrow-band to achieve the required coherence length of the emission.

In one development, an optical beam forming device is arranged between the light source and the surface with the plurality of phase delay cells for uniform illumination of the surface. The beam forming device preferably comprises a spatial filter and one or more lenses.

### BRIEF DESCRIPTION OF THE DRAWINGS

The present invention will hereinafter be described in conjunction with the following drawing figures, wherein like numerals denote like elements, and

FIG. 1 shows a schematic structure of a holographic projection system;

FIG. 2 shows a schematic structure of an adjustable diffractive element; and

FIG. 3 shows a schematic sketch of an arrangement for devices of an embodiment.

In the figures, the same reference numerals designate the same or functionally the same elements.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

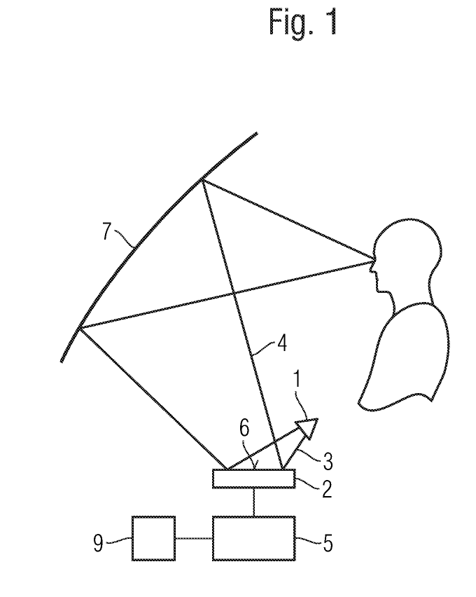

A preferred configuration of the holographic information display is shown schematically in FIG. 1.

A coherent light source 1 preferably emits light of a single wavelength. Lasers, for example laser diodes, are preferably used as the light source 1 as these have an adequate coherence length. Spatial filters are optionally connected downstream from the light source to filter out undesired scattered light. A spatial filter can be implemented by an aperture plate which is located at the focal point of two lenses arranged around it. However, this is purely optional.

The light source 1 illuminates a spatially-resolved diffractive panel 2. The diffractive panel 2 delays the reflected light 4 in a locally different manner relative to the emergent light 3. The diffractive panel 2 is activated by a control device 5. The control device 5 specifies in which regions of the surface 6 the diffractive panel 2 delays the reflected light 4 and how strongly.

The spatially-resolved phase delay reproduces a hologram. The hologram is provided for the control device 5 by a data processing device 9 in a suitable manner. The hologram is preferably determined by the data processing device 9 from a predetermined two-dimensional or three-dimensional model of a display element. The inner spatialities of the vehicle are also preferably taken into account here. Furthermore, the holograms may be loaded from a memory of the data processing device 9. Typical texts or pictograms to be superimposed are already stored in the memory.

The light reflected by the diffractive panel 2 according to the hologram leads to a reconstructed hologram according to the two-dimensional or three-dimensional model of the display element, which an observer, for example the driver of a vehicle, can perceive as a model.

The reflected light beams are guided in the direction of a windscreen 7 of the vehicle and deflected by the windscreen 7 into the eyes of the driver. The driver perceives the reconstructed hologram as being in the region of the windscreen 7 or behind the windscreen. The perceived distance of the reconstructed hologram from the windscreen is predetermined by the hologram. The perceived distance may be varied by an adaptation of the hologram.

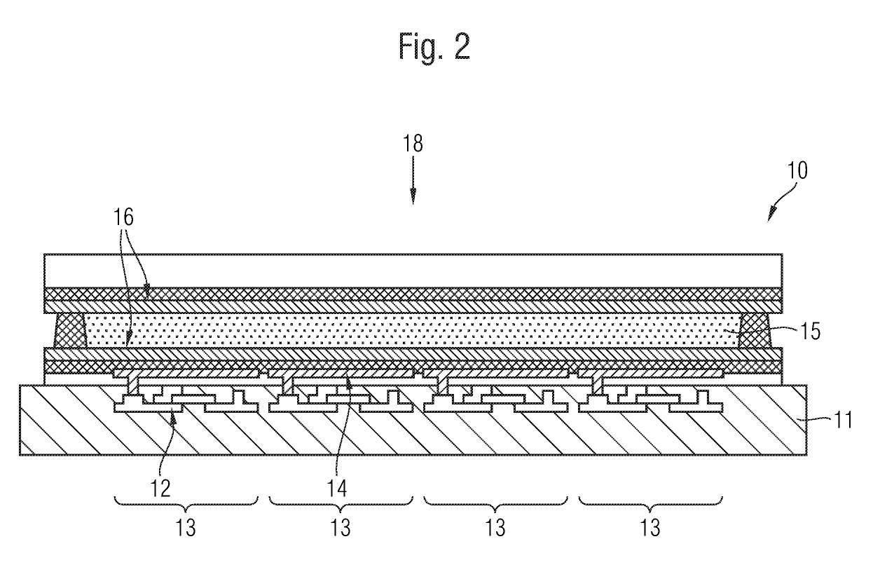

A possible structure of a diffractive panel 10 is shown in FIG. 2. A plurality of individually activatable electrodes 12, which divide the panel 10 into cells 13, is implemented in a semiconductor substrate 11. Mirrors 14 for reflecting incident light beams are arranged above the electrodes 12. A layer 15 with a liquid crystal material is applied above the mirrors 14. The liquid crystal material may contain ferroelectric liquid crystal material.

The light is incident from a direction 18 onto the diffractive panel. In this case, the light traverses the liquid crystal layer 15 and is reflected back by the mirror elements 14. The arrangement may be used with normal incidence or with oblique incidence. The incident light undergoes a phase delay when traversing the liquid crystal layer 15. The phase delay is adjusted by applying an electric potential to the electrodes 12.

In a simple variant, precisely two different electrical signals, which lead to a first phase delay and to a phase delay increased by 180 degrees relative to the first phase delay, can be applied at the electrodes 12.

In other configurations, stepped voltage levels can be applied at the electrodes 12 so relative phase delays of fractions of 180 degrees can be implemented.

Polarisation filters are preferably arranged above and/or below the liquid crystal layer. These filter out undesired polarisation states. Instead of the polarisation filters, pole beam splitters may also be used which reflect one polarisation plane and transmit the other polarisation plane.

When determining the hologram, the optical path of the light wave fields through the vehicle interior is also taken into account. In particular, the hologram is adapted to the surface contour of the windscreen 7 and optionally also to the thickness of the windscreen 7 or even the thickness profile of the windscreen 7. In this manner, the driver sees an undistorted virtual display element. The adaptation of the hologram and the display element is achieved without adaptation of optical elements, such as lenses, mirrors, etc. It is sufficient to merely program in new holograms according to which the adjustable diffractive panel 2 is activated.

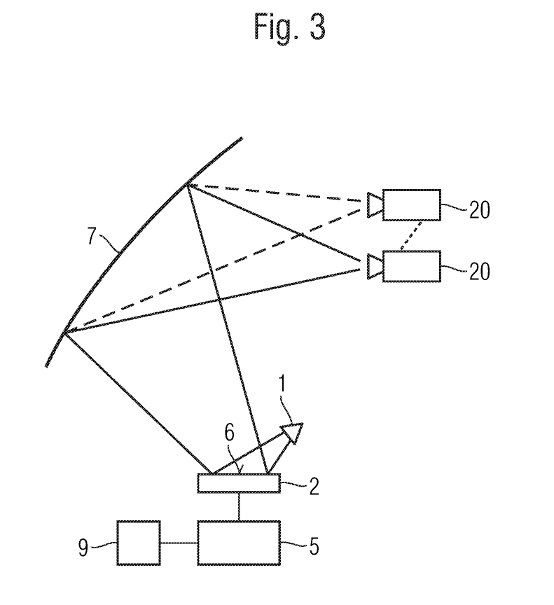

The holograms may be set up during the initial installation of the diffractive panel. The setting up may take place with an arrangement shown in FIG. 3. A plurality of holograms is preferably reconstructed pertaining to test patterns. The holograms with test patterns may be provided by the data processing device 9 and reconstructed by means of the diffractive panel 3 and the light source. Using the reconstructed holograms and therefore the test patterns shown, spatial variations in the vehicle, for example the shape of the windscreen 7, can be gauged.

The test holograms are recorded by a camera 20. The camera is preferably moved into various predetermined positions from which the reconstructed hologram(s) are recorded. An evaluation device compares the recorded reconstructed holograms at the respective positions with predefined values to determine the deviations.

The adaptations carried out are stored as vehicle parameters. When calculating or providing holograms for virtual display elements, these vehicle parameters are taken into account. The holograms are correspondingly modified. As a result, the use of correction lenses or mirrors for adaptation of the projection system to various vehicles can be dispensed with.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A holographic information display for a motor vehicle for projecting a virtual display element, comprising:
a data processing device for providing a hologram for the virtual display element to be projected;
a control device, which in each case emits an individual control signal for a plurality of segments of the hologram;
a light source for emitting a light beam; and
a plurality of optical phase delay cells which can be individually adjusted by the control device and are arranged on a face illuminated by the light beam to delay the fraction of the light beam which is incident thereon in each case in phase in response to the respective individual control signal.

2. The holographic information display according to claim 1, wherein the plurality of optical phase delay cells are operated in transmission mode.

3. The holographic information display according to claim 1, wherein the plurality of optical phase delay cells are operated in reflection mode.

4. The holographic information display according to claim 1, wherein the plurality of optical phase delay cells are arranged in rows and columns.

5. The holographic information display according to claim 1, wherein the phase delay cells are arranged on a flat surface.

6. The holographic information display according to claim 1, wherein a delay means is provided in the plurality of optical phase delay cells, by means of which the phase of the incident light beam can be delayed between about 0 degrees and 180 degrees in at least two steps.

7. The holographic information display according to claim 1, wherein a delay means is provided in the plurality of optical phase delay cells, by means of which the phase of the incident light beam can be continuously delayed between about 0 degrees and 180 degrees.

8. The holographic information display according to claim 6, wherein the delay means is at least partially formed by liquid crystals, which, in response to an electric field generated by the control signal, delay the phase of the incident light beam.

9. The holographic information display according to claim 1, wherein the data processing device has a computing device for determining the hologram for the virtual display element to be projected.

10. The holographic information display according to claim 1, wherein the data processing device is integrated in the control device.

11. The holographic information display according to claim 1, wherein the light source is configured as a coherent light source for emitting a coherent light beam.

12. The holographic information display according to claim 1, wherein the light source is a laser light source.

13. The holographic information display according to claim 1, wherein an optical beam forming device is arranged between the light source and the surface with the plurality of phase delay cells for uniform illumination of the surface.

14. The holographic information display according to claim 1, wherein the projected virtual display element is directed by a deflection device into the range of vision of a driver of the motor vehicle.

15. The holographic information display according to claim 14, wherein the deflection device is the windscreen of the vehicle.

16. A method for projecting a virtual display element using a holographic information display, comprising the steps of:
providing a hologram for a two-dimensional or three-dimensional virtual display element by means of a data processing device;
emitting individual control signals for a plurality of portions of the hologram by means of a control device;
adjusting the respective phase delay of the plurality of phase delay cells in response to a respective individual control signal; and
illuminating the plurality of phase delay cells by means of a light source, whereby the virtual display element is generated by the phase-delayed light beams of the light source.

17. The method according to claim 16, further comprising the step of deflecting the light beams phase-delayed by the hologram with an optical deflection device into a range of vision of a driver.

18. The method according to claim 17, further comprising the step of accounting for the imaging errors of the optical deflection device in a corrective manner in the hologram.
